(19) United States
(12) Patent Application Publication
(10) Pub. No.: US 2025/0285284 A1
(43) Pub. Date: Sep. 11, 2025

(54) METHOD AND DEVICE FOR SEGMENTING AN OBJECT IN A SOURCE IMAGE

(71) Applicant: Siemens Healthineers AG, Forchheim (DE)

(72) Inventors: Halid Yerebakan, Carmel, IN (US); Gerardo Hermosillo Valadez, West Chester, PA (US)

(21) Appl. No.: 19/043,614

(22) Filed: Feb. 3, 2025

(30) Foreign Application Priority Data
Mar. 5, 2024 (DE) 10 2024 106 376.9

(51) Int. Cl. G06T 7/11; G06T 5/20; G06T 7/00

(52) U.S. Cl. CPC G06T 7/11; G06T 5/20; G06T 7/0012; G06T 2207/10081; G06T 2207/10088; G06T 2207/10104; G06T 2207/10132

(57) ABSTRACT

Method and device for segmenting an object in a source image. A source image showing details of the object is provided and an element of the object is selected. A segmentation region in the source image comprising the selected element is determined. A segmentation mask is prepared by segmenting the determined segmentation region, wherein at least the selected element or its components are segmented. The segmentation mask is then output.

### CROSS-REFERENCE TO RELATED APPLICATION

This application claims the benefit of priority from German Patent Application No. 102024106376.9, filed on Mar. 5, 2024, the contents of which are incorporated by reference.

### TECHNICAL FIELD

The present framework describes segmenting an object in a source image, a control-unit for a medical imaging system and a medical imaging system for acquiring and/or examining medical images.

### BACKGROUND

Segmentation is a fundamental task in medical imaging. It is used in visualization, automation, quantification, and follow-up in radiology workflows. In this domain, machine learning methods have gained an advantage over traditional algorithms, thanks to the rise of available data in recent years. However, as is often the case, a speed-accuracy trade-off exists in machine learning systems. They typically do not provide a good user experience due to lag when graphics processing unit (GPU) accelerators are not available.

Recently, a fast point-matching-based segmentation algorithm has been created that reduces the required computations by using sparse data as input. This algorithm is based on a classifier that allows queries on class labels at any level of detail. Despite the easy adaptability of the point-matching-based segmentation algorithm, a full volume grid scan is typically used to compute segmentation masks. However, in some use cases, such as single organ segmentation, a full grid scan is unnecessary.

State of the art registration methods utilize transformer architectures. Especially pre-trained autoencoders have demonstrated better generalization ability after fine tuning on target segmentation tasks alleviating the need of labeled training data (see e.g., Valanarasu, Jeya Maria Jose, et al. “Disruptive Autoencoders: Leveraging Low-level features for 3D Medical Image Pre-training.” arXiv preprint arXiv:2307.16896; 2023, which is herein incorporated by reference). However, with the quadratic scaling computational complexity it is difficult to achieve smooth user experience on runtime. Thus, the segmentation masks need to be precomputed and stored which increases the cost of computation and storage and architectural design.

Interactive approaches such as region growing allow users to use the segmentation for various tasks. The size and the region are defined by user actions while considering the intensity information automatically. As a result of manual operations, obtaining good results requires additional care and time.

“Segment Anything” models have demonstrated the ability of obtaining segmentation with single click on natural images (see e.g., Kirillov, Alexander, et al. “Segment anything.” arXiv preprint arXiv: 2304.02643; 2023, which is herein incorporated by reference). However, there is still no contextual information enforcing segmentation into certain regions to prevent false positives. Also, three-dimensional (3D) versions will still have computational time constraints mentioned before.

### SUMMARY

Described herein is a framework for segmenting an object in a source image. A source image showing details of the object is provided and an element of the object is selected. A segmentation region in the source image comprising the selected element is determined. A segmentation mask is prepared by segmenting the determined segmentation region, wherein at least the selected element or its components are segmented. The segmentation mask is then output.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings.

FIG. 1 shows a computed tomography (CT)-system as an example for an imaging system;

FIG. 2 shows an atlas of a human body with some bounding boxes;

FIG. 3 shows an example for determining a segmentation region; and

FIG. 4 shows a block diagram of an exemplary method for segmenting an object in a source image.

### DETAILED DESCRIPTION

It is the object of the present framework to improve the known systems and methods and provide a method and a device for segmenting an object in a source image, a control-unit for a medical imaging system and a medical imaging system for acquiring and/or examining medical images, for overcoming the above-described problems.

The method according to the framework serves to segment an object in a source image. It comprises the following steps: providing a source image showing details of the object, selecting an element of the object, determining a segmentation region in the source image comprising the selected element, preparing a segmentation mask by segmenting the determined segmentation region, wherein at least the selected element and/or its components are segmented, and outputting the segmentation mask.

The method facilitates a fast segmentation of organs with a single click while restricting the region of segmentation (i.e., the segmentation region, e.g., a bounding box). Since the segmentation region is typically smaller than the source image, the process of segmentation is concentrated onto a small volume and, therefore, faster. Here it should be noted that the segmentation region is just a relatively small region around an area of interest comprising the selected element. The method could e.g., be performed very fast by utilizing predefined bounding boxes in a normal body atlas.

The object may be an inanimate thing, e.g., a suitcase, or a living entity, e.g., an animal or a human. The source image shows the interior of the object, e.g., organs of a human. The source image may be recorded with radiography, computed tomography (CT), sonography or magnetic resonance imaging (MRI). The method is particularly advantageous for three dimensional images.

First, this source image is provided, e.g., recorded or downloaded from a database. It shows details of the object, i.e., the elements of the object, especially the interior elements of this object, e.g., organs of a human or animal.

An element of the object, e.g., an organ of a person, in the source image, is selected. This could be done by pointing on a position of the source image or by naming the element, e.g., the “liver” or the “lung”. The selection could also be done automatically, e.g., in the case many images have to be examined for a special issue of an element or for statistical calculations.

Based on this selection, the segmentation region is determined in the source image. This segmentation region comprises the selected element, i.e., the selected element is inside this segmentation region. The segmentation region could be imagined as e.g., a bounding box around the selected element, but could also be an irregular volume comprising the element. However, the method may be very fast when using a bounding box, since it is easy to calculate and to adjust in the case, the element should exceed a preliminary arranged bounding box.

The segmentation region should be as big as necessary in order to enclose the whole element (fully), but as small as possible to be segmented in a fast manner. In some implementations, the segmentation region has not more than three times the volume of the element (e.g., less than two times). However, sometimes the “element” could have a tree-like structure, e.g., being a vascular region. Then with “volume” is meant an embracing volume comprising also the space between the branches. A bounding box as segmentation region should have less than four times the width of the element and/or less than four times the length of the element and/or less than four times the height of the element (e.g., less than two times).

In some implementations, the present framework determines the segmentation region in a model of the object, e.g., an atlas of a body. For example, such atlas already comprises the position of organs surrounded by a bounding box. Alternative or additional to a graphical atlas, there may be a list of organs and the coordinates of their bounding boxes. A user may input a word (“e.g., “liver”) and the list retrieves the position and size of the bounding box e.g., with the coordinates (xmax, xmin, ymax, ymin, zmax, zmin). A user may also point on an organ in the source image or in the atlas in order to retrieve the bounding box of the organ pointed at. This proceeding is very fast and provides a preliminary segmentation region (the retrieved bounding box).

This preliminary segmentation region may directly be determined to be the segmentation region, for example, by using BodyGPS-coordinates to locate the correct position in the source image. BodyGPS is a well-known algorithm that normalizes body-coordinates into an atlas coordinate system in order to provide comparable coordinates.

However, since it originates from a model, the real element may exceed the segmentation region, e.g., because it is a little bit bigger than in the model or located at a slightly different position. Thus, a bounding box defining the expected segmentation region could be extended from the original definition. In some implementations, the preliminary segmentation region is fitted to the correct position and size (or form) in the source image. To automate this step, a fast segmentation of the source image could be performed (with a basic set of labels and/or on a predefined coarse grid) and the preliminary segmentation region is fitted based on this segmentation. The fitted preliminary segmentation region is then the determined segmentation region.

After the segmentation region is determined, the segmentation mask is prepared by segmenting the determined segmentation region. This segmentation mask comprises information about the elements in the segmentation region. Such segmentation masks are well known in the art and are typical results of segmentation procedures. For example, they represent the pixels of the image, wherein each pixel is labeled to say to which element it belongs.

The characteristic feature of the method according to the framework is not the formation of the segmentation mask itself, but the fact that segmentation is solely performed in the segmentation region and not in the whole source image. Thus, it could be done fast and effective (e.g., by labeling the pixels of the segmentation region showing “element” or “not element”). A further advantage is that the segmentation in the segmentation region could be done by using a very fine grid, especially resolving individual components of the element.

The prepared segmentation mask is then output, e.g., saved in a database or shown on a display for examination.

In short, the method according to the present framework uses a segmentation region given by a selection of a user so that a segmentation algorithm could be localized to a selected element (organ). This approach not only reduces the required computation but also improves accuracy thanks to reduced false positive matches for the selected element. With this technology, a user could e.g., activate a tool doing segmentation, click on any desired organ of a body, and receive near-real-time segmentation.

Regarding a body (e.g., human body), a user may navigate on the source image, go to a desired location and decide to get segmentation of an organ by clicking on a point of this organ. This may be done after activating a tool for segmentation, but this tool may also be activated by the click. This selection may be a single point click, but also drawing a box or circle or by scribble (see e.g., Xi Chen et al. “ScribbleSeg: Scribble-based Interactive Image Segmentation” arXiv: 2303.11320v1 [cs.CV] 20 Mar. 2023, which is herein incorporated by reference). In some cases, a textbox could also be used for the selection of the element. This could be computed with a natural language processing semantic search system and parsed in the list mentioned above.

To identify an organ, a Fast Segmentation routine and/or BodyGPS could be used, or a fast segmentation classifier could provide a direct label to the selected point in the source image. BodyGPS maps a point into an atlas coordinate system where either a bounding box or an atlas segmentation mask could be used to determine the organ in selection. In both systems the execution is similar. A shape descriptor, especially a point matching descriptor (reducing object-clouds into point-structures), can be computed in the source image location. Then a multi-layer neural network provides either the organ label or atlas coordinate normalization. The organ could also be identified by registering the atlas on the source image and transferring the selected point to the coordinate system of the atlas.

Once the organ is identified, corresponding atlas coordinates of a bounding box for the organ could be retrieved from a bounding box database.

Then, the selected bounding box needs to be transferred into the source image to define the segmentation region. The original image coordinate is known in the click location and the atlas coordinate is estimated with BodyGPS. Subtracting the offset from the edges of the bounding box will create an initial estimate of bounding box coordinates in the source image.

This initial estimate may not be exact due to different patient sizes. Thus, it is advantageous to calibrate the position and/or size of the selected bounding box.

Calibration could be done via BodyGPS coordinate search. That is, starting with initial estimate location (either start or end of a bounding box), finding the corresponding normalized location for the initial estimate in the atlas, checking the difference between a selected bounding box target edge and computing the difference. This procedure would create a new offset value to move. These steps could be repeated until the estimated normalized coordinate and target bounding box location is close enough. This operation is similar to BodyGPS landmark search. The only difference is in this case the bounding box edges are given as landmark locations. Once the bounding box is mapped back to the original source image, its boundaries may slightly be extended to avoid missing some of the parts in the organ due to deformities or orientations.

More detailed bounding boxes could be refined after locating the initial bounding box. For example, a bounding box could be computed for every slice in the source image. However, this may take additional time.

After the segmentation region (e.g., the bounding box) is positioned in the source image (e.g., with the boundary coordinates (xstart, xend, ystart, yend, zstart, zend), the segmentation region could be segmented. Since the segmentation region is relatively small, a fine grid could be defined in a desired resolution for segmentation. This grid would be smaller than the full image grid (for the fast segmentation) and thus has potential to reduce computational time below 1 s. For every grid point a point matching descriptor could be computed and a neural network could process these descriptors to obtain estimated organ labels. Labels coming for other organs in multi class classification setting could be removed since the selection of the organ gives the label of desired organ.

Finally, once the segmentation mask is ready, a user could see the mask as overlays or 3D visualizations. On the overlays segmentation brush or polygon tools could allow them to reedit the mask if needed. Additionally, automated connected component analysis could be run to cluster regions in the segmentation mask to allow user the select from them. User interactions could be modified according to desired use cases.

The device according to the framework serves to segment an object in a source image. It comprises: a data interface designed to receive a source image showing details of the object, a selection-unit designed for selecting an element of the object, a region-unit designed for determining a segmentation region in the source image comprising the selected element, a mask-unit designed for preparing a segmentation mask by segmenting the determined segmentation region, wherein at least the selected element and/or its components are segmented, and a data interface designed for outputting the segmentation mask.

The device may also comprise a model unit with information about a model of the object (e.g., said atlas) comprising information about elements of this object and regions (e.g., bounding boxes) surrounding these elements, and/or a list of the elements and the coordinates of their regions. In some implementations, the device is designed to determine a segmentation region by identifying an element of the model, especially of the list, and its region as segmentation region.

In some implementations, the device is designed for performing the method according to the framework. The function of the components of the device is described above.

The control-unit serves for controlling a medical imaging system. It comprises a device according to the framework and/or is designed to perform a method according to the framework.

A medical imaging system is especially a system for acquiring and/or examining medical images. It comprises the control unit according to the framework.

Some units or modules of the framework mentioned above can be completely or partially realized as software modules running on a processor of a computing system. A realization in the form of software modules can have the advantage that applications already installed on an existing computing system can be updated, with relatively little effort, to install and run these units of the present application. The object of the framework is also achieved by a computer program product with a computer program that is directly loadable into the memory of a computing system, and which comprises program units to perform the steps of the methods, at least those steps that could be executed by a computer, when the program is executed by the computing system. In addition to the computer program, such a computer program product can also comprise further parts such as documentation and/or additional components, also hardware components such as a hardware key (dongle etc.) to facilitate access to the software.

One or more non-transitory computer readable media, such as a memory stick, a hard-disk or other transportable or permanently-installed carrier, can serve to transport and/or store the executable parts of the computer program product or machine readable instructions so that these can be read and executed by one or more processor units of a computing system to perform the methods according to the present framework. A processor unit can comprise one or more microprocessors or their equivalents.

Particularly advantageous embodiments and features of the framework are given by the dependent claims, as revealed in the following description. Features of different claim categories may be combined as appropriate to give further embodiments not described herein.

In some implementations, the segmentation region is a volume-representation of the selected element (e.g., the region of the element) or a bounding box around the selected element. It may be determined based on identifying a respective region in the source image or in a model of the object, e.g., an atlas. In the case the element is identified in the model, the segmentation region should be transferred into the source image. Another procedure of determining the segmentation region is selecting a respective region in the source image in the course of selecting the element. For example, when the element is encircled by a drawn box or circle during the selection, this could also be used to define the segmentation region.

In some implementations, the segmentation region is determined by pre-segmenting the object in the source image with a pre-segmentation routine (above described as “Fast Segmentation”) into basic elements and determining the segmentation region based on this pre-segmentation. This pre-segmentation may be done only on a coarse grid and/or with a reduced labelling. A fine segmentation may foil the advantage of the method since it needs much time.

All pixels of the pre-segmented image may have a label referring to a chosen element and/or to the label of a pixel selected by pointing on it are determined to belong to the segmentation region.

A method comprises the following steps: identifying the selected object and at least one coordinate of its position in the object, e.g., by using a selected coordinate or a known coordinate of the selected element in the object or in a model of the object, especially by retrieving a label for the identified element, and determining the coordinate from a database (e.g., a bounding-box database), and determining the segmentation region from a model of the object and the coordinate and combining this segmentation region with the according coordinate of the source image. Optionally, the size and/or shape and/or orientation and/or position of the segmentation region relative to the source image is calibrated based on picture information of the source image.

How an element could be identified is described above. It could be done by identifying a name input for selection or identifying what element was pointed on by a user for selection. This identification may be omitted when a user has drawn something in the source image that could directly be used as segmentation region.

The determination of the segmentation region has also already been described above. It could be taken from a list or atlas or from a Fast Segmentation step, e.g., all cells from a grid having the same label as the cell selected. This segmentation region then should be transferred to the source image and adjusted accordingly.

However, the adjusting is optional. For example, it is possible to register the model on the object of the source image and then register the segmentation region accordingly as the respective region of the model.

It should be noted that people have different sizes, shapes orientation of organs. Thus, it is better to give more room to the segmentation region than that of an original atlas bounding box.

In some implementations, the model comprises a list of elements and coordinates of regions, especially bounding boxes, comprising (surrounding) these elements. Coordinates of regions may be chosen as segmentation region by identifying an element of the list to be a selected element. In some implementations, in the case the selection is based on a selected coordinate, the element of the list is identified by the location of the element in the model and the selected coordinate mapped on the model. A bounding box database is like a dictionary. Thus, if bounding box coordinates in a model could also be retrieved by inputting a word referring to a desired element. Once bounding box coordinates are known, a coordinate routine e.g., bodyGPS, could be used to map those coordinates back to the source image.

In some implementations, the segmentation mask is prepared by the following steps: defining a grid over the segmentation region with a predefined resolution, wherein the resolution of this grid may be smaller than the grid-resolution of a pre-segmentation, and labeling every grid point in the course of a segmentation procedure in order to obtain labels for the element and/or for sub-structures of the element.

Segmentation routines are well known in the art. The special advantage of the framework shows, when the segmentation is solely done in the segmentation region. This segmentation region is not the whole source image, but a region around the element. Generally, it could be said that it is advantageous when the segmentation region, regarding a spatial direction in the source image, is smaller than two times the dimension of the element in this spatial direction. Regarding a bounding box, its height should be not more than two times the height of the element, the same with the length and the width.

An optional step is: removing labels concerning other elements of the object. Thus, only the object (and possibly its components) is segmented, but other elements not selected are ignored. For example, when selecting the heart of a human, the lung also being partly present in the segmentation region is ignored.

In some implementations, the element (e.g., an organ) may be selected in several possible manners. In some implementations, it is selected by selecting a position of the element in the source image by pointing on at least a point in the source image. Then, the source image could be segmented with a pre-segmentation (a Fast Segmentation procedure) and the label of the cell pointed on could be identified. On the other hand, the coordinate could be transferred to the model and it could be identified what element is at this position in the model.

In some implementations, the element is selected by selecting a region in the source image, especially a spheric region or a rectangular box or scribble, e.g., by drawing coarse lines in the source image defining regions to belong together. A given region could also be used to indicate the segmentation region.

In some implementations, the element is selected by inputting an expression of the element, e.g., the name of an organ, and determining the position of the element in the source image based on prior knowledge and/or based on a fast pre-segmentation step.

In some implementations, the element is selected by inputting an expression of the element and determining the segmentation region by using a list of elements combined with their segmentation regions or a model with given segmentation regions.

The query representation could be computed with a natural language processing semantic search system known in the art and mapped to a most similar box definition.

In some implementations, the element is selected by using a predefined position or element in the image or in the model. This could e.g., be applied when it is intended to parse many source images for statistical reasons or to compare certain elements with each other.

In some implementations, the element is selected by using information about an examination of the object, e.g., such as “reason for exam: kidney stone”, then the kidneys are selected as elements.

In some implementations, the step of outputting the segmentation mask comprises the sub-steps: visualizing the segmentation mask over the source image, e.g., as overlays or 3D visualizations, and altering or adjusting the segmentation mask based on the source image, e.g., with a segmentation brush or polygon tools, and/or performing an automated connected component analysis in order to cluster regions in the segmentation mask.

In some implementations, the source image is a medical image, especially a two-dimensional or three-dimensional image, such as a computed tomography (CT)-image, magnetic resonance tomography (MRT)-image, positron emission tomography (PET)-image, Ultrasound-image, X-ray image or tomosynthesis image, especially wherein the source image is an image of a body (e.g., a human body).

AI-based methods (AI: “artificial intelligence”) may be used for the method according to the present framework, especially for the segmentation. Artificial intelligence is based on the principle of machine-based learning and is usually carried out with an adaptive algorithm that has been trained accordingly. The expression “machine learning” is often used for machine-based learning, which also includes the principle of “deep learning”.

The methods may also include elements of “cloud computing”. In the technical field of “cloud computing”, an IT infrastructure is provided over a data-network, storage space or pro-cessing power and/or application software. The communication between the user and the “cloud” is achieved by means of data interfaces and/or data transmission protocols. In the context of “cloud computing”, provision of data via a data channel (for example a data-network) to a “cloud” may take place. This “cloud” includes a (remote) computing sys-tem, e.g., a computer cluster that typically does not include the user's local machine. The cloud service may provide computing power as application software.

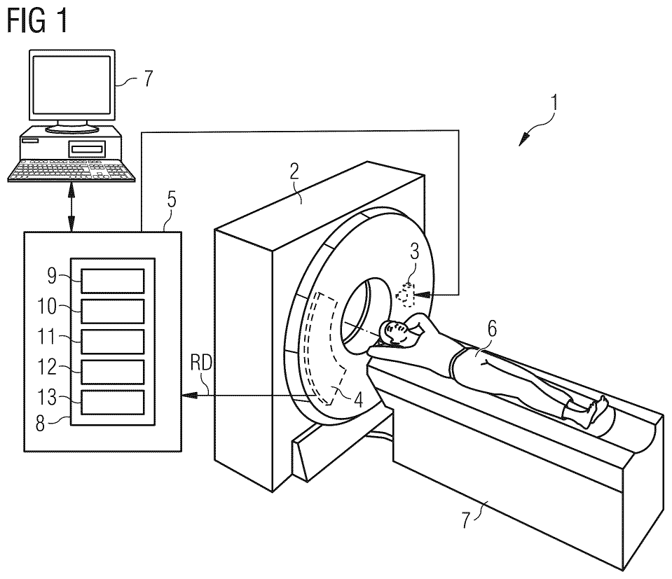

FIG. 1 shows a simplified computer tomography system 1 with a control-unit 5 comprising a device 8 according to the framework (for carrying out the method according to the framework). The computer tomography system 1 has in the usual way a scanner 2 with a gantry, in which an x-ray source 3 with a detector 4 rotates around a patient 6 and records raw data RD that is later reconstructed to a source image SI by the control-unit 5.

It is pointed out that the exemplary embodiment according to this figure is only an example of an imaging system and the framework can also be used on any imaging system that is able to produce source images SI used in medical and non-medical environment. Likewise, only those components are shown that are essential for explaining the present framework. In principle, such imaging systems and associated control devices are known to the person skilled in the art and therefore do not need to be explained in detail.

The imaging system (here the CT system 1) records source images SI that are segmented by the device 8 that is designed to perform the method according to the framework (see FIG. 4). The device 8 comprises a data interface 9, a selection-unit 10, a region-unit 11, a mask-unit 12, and a model unit 13.

The data interface 9 is designed to receive the source image SI and for outputting the resulting segmentation mask M e.g., on terminal 7. An examination with the help of the segmentation mask M can then be performed on the terminal 7.

The selection-unit 10 is designed for selecting an element E of the object 6.

The region-unit 11 is designed for determining a segmentation region R in the source image SI comprising the selected element E.

The mask-unit 12 is designed for preparing a segmentation mask M by segmenting the determined segmentation region R, wherein at least the selected element E and/or its components are segmented.

The model unit 13 comprises information about a model A of the object 6 and elements E of this object 6 surrounded by regions. It can also comprise a list of the elements E and the coordinates of their regions.

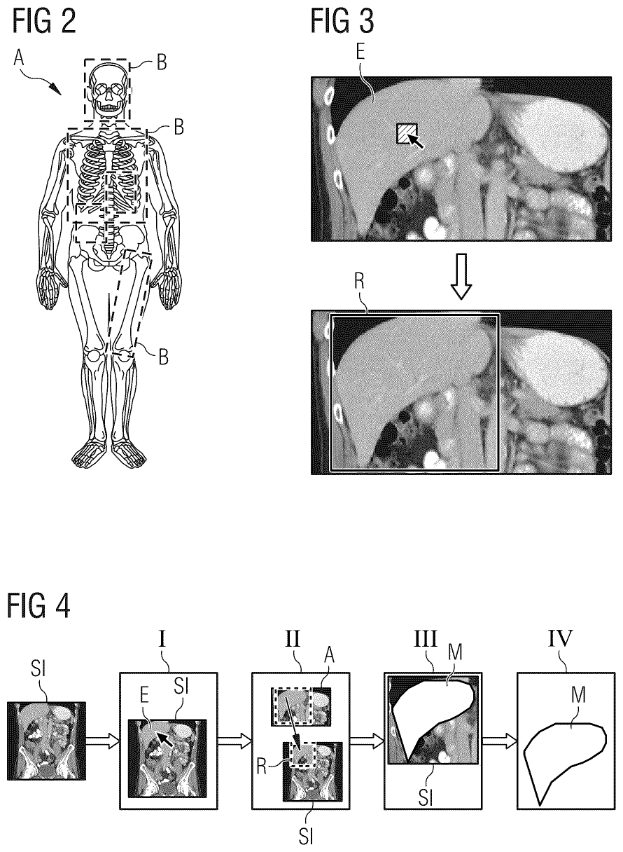

FIG. 2 shows an atlas M as a model M of a human body with some bounding boxes B. These bounding boxes B may be connected to bones, organs or vessels. Here, only three bounding boxes are shown (head, thorax, femur). In reality, an atlas comprises bounding boxes for a vast number of bodyparts (elements).

FIG. 3 shows an example for determining a segmentation region R. A user points (arrow) on a cell in the source image SI, e.g., a pixel or a region (top image). Then this element is surrounded by a bounding box B as segmentation region R (bottom image), e.g., retrieved from a model as shown in FIG. 2.

FIG. 4 shows a block diagram of an example for the method for segmenting an object 6 in a source image SI.

First, a source image SI is provided, showing details of the object 6. Here the object is a patient 6 and the source image SI is a CT image e.g., recorded with the CT-system of FIG. 1.

In step I an element E, here an organ E, of the patient 6 is selected. This is done here by pointing on a position of the source image SI (arrow).

In step II a segmentation region R is determined in the source image SI. This segmentation region R is here a fitted bounding box B comprising the selected element. The bounding box is identified in an Atlas A (see e.g., FIG. 2) and transferred to the source image SI and adjusted accordingly.

In step III a segmentation mask M is prepared by segmenting the determined segmentation region R. Here only the selected element E is segmented. It is also possible that also its components are segmented.

In step IV the segmentation mask M is output. It could be output as overly to the source image SUI as shown in step III.

Although the present framework has been disclosed in the form of preferred embodiments and variations thereon, it will be understood that numerous additional modifications and variations could be made thereto without departing from the scope of the framework. For the sake of clarity, it is to be understood that the use of “a” or “an” throughout this application does not exclude a plurality, and “comprising” does not exclude other steps or elements. The expression “a number of” means “at least one”. The mention of a “unit” or a “device” does not preclude the use of more than one unit or device. Independent of the grammatical term usage, individuals with male, female or other gender identities are included within the term.

### LIST OF REFERENCE

1 computer tomography system/CT-system
2 scanner
3 X-ray source
4 detector
5 control-unit
6 object/patient
7 bed
8 device
9 data interface
10 selection-unit
11 region-unit
12 mask-unit
13 model-unit
A atlas/model
B bounding box
E element/organ
M segmentation mask
R segmentation region
RD raw data
SI source image

What is claimed is:

1. A method for segmenting an object in a source image, comprising:
providing a source image showing details of the object;
selecting an element of the object;
determining a segmentation region in the source image comprising the selected element;
preparing a segmentation mask by segmenting the determined segmentation region, wherein at least the selected element or its components are segmented; and
outputting the segmentation mask.

2. The method according to claim 1, wherein the segmentation region is a volume-representation of the selected element or a bounding box around the selected element.

3. The method according to claim 1, wherein the segmentation region is determined by
identifying a region in the source image,
identifying a respective region in a model of the object and transferring the respective region into the source image, and
selecting a respective region in the source image while selecting the element of the object.

4. The method according to claim 3, comprising:
identifying the selected element and at least one coordinate of a position of the selected element in the object and determining the coordinate from a database; and
determining the segmentation region from a model of the object and the coordinate and combining the segmentation region with the coordinate of the source image.

5. The method according to claim 4 wherein identifying the selected element and the at least one coordinate of the position of the selected element in the object comprises using a selected coordinate or a known coordinate of the selected element in the object or in a model of the object, and retrieving a label for the identified selected element.

6. The method according to claim 4 further comprising calibrating size, shape, orientation, position or combination thereof of the segmentation region relative to the source image based on picture information of the source image.

7. The method according to claim 4, wherein the model comprises a list of elements and coordinates of regions comprising the list of elements, wherein the coordinates of regions are chosen as the segmentation region by identifying an element of the list to be a selected element.

8. The method according to claim 7 wherein selecting the element is based on a selected coordinate, the element of the list is identified by location of the element in the model and the selected coordinate is mapped on the model.

9. The method according to claim 1, wherein the segmentation region is determined by pre-segmenting the object in the source image with a pre-segmentation routine into basic elements and determining the segmentation region based on this pre-segmentation.

10. The method according to claim 1, wherein the segmentation mask is prepared by
defining a grid over the segmentation region with a predefined resolution, and
labeling every grid point during a segmentation procedure in order to obtain labels for the element or for sub-structures of the element.

11. The method according to claim 10 further comprising removing labels concerning other elements of the object.

12. The method according to claim 1, wherein the element is selected by
selecting a position of the element in the source image by pointing on at least a point in the source image,
selecting a region in the source image,
inputting an expression of the element and determining the position of the element in the source image based on prior knowledge or a fast pre-segmentation step,
inputting the expression of the element and determining the segmentation region by using a list of elements and their segmentation regions or a model with given segmentation regions,
using a predefined position or element in the source image or in the model, or
using information about an examination of the object.

13. The method according to claim 1 wherein selecting the region in the source image comprises selecting a spheric region, a rectangular box or scribble.

14. The method according to claim 1, wherein outputting the segmentation mask comprises:
visualizing the segmentation mask over the source image, and
altering or adjusting the segmentation mask based on the source image or performing an automated connected component analysis in order to cluster regions in the segmentation mask.

15. The method according to claim 1, wherein the source image is a medical image.

16. The method according to claim 15 wherein the source image is a computed tomography (CT)-image, magnetic resonance tomography (MRT)-image, positron emission tomography (PET)-image, Ultrasound-image, X-ray image or tomosynthesis image.

17. A device for segmenting an object in a source image, comprising:
a data interface that receives a source image showing details of the object;
a selection-unit that selects an element of the object;
a region-unit that determines a segmentation region in the source image comprising the selected element;
a mask-unit that prepares a segmentation mask by segmenting the segmentation region, wherein at least the selected element or its components are segmented; and
a data interface that outputs the segmentation mask.

18. The device according to claim 17, comprising a model unit with information about a model of the object and elements of the object surrounded by regions, wherein the device determines a segmentation region by identifying an element of the model and a region of the element as the segmentation region.

19. The device according to claim 18 wherein the information comprises a list of elements and coordinates of their regions.

20. One or more non-transitory computer-readable media comprising machine-readable instructions, that when executed by one or more processor units, cause the one or more processor units to perform steps comprising:
providing a source image showing details of an object;
selecting an element of the object;
determining a segmentation region in the source image comprising the selected element;
preparing a segmentation mask by segmenting the determined segmentation region, wherein at least the selected element or its components are segmented; and
outputting the segmentation mask.
